(19) United States
(12) Patent Application Publication
(10) Pub. No.: US 2016/0106086 A1
(43) Pub. Date: Apr. 21, 2016

(54) FISHING ALARM APPARATUS

(71) Applicants: Dan Braaten, Oakdale, MN (US); Gary Skogman, Rush City, MN (US); Mario Carrillo, Minneapolis, MN (US)

(72) Inventors: Dan Braaten, Oakdale, MN (US); Gary Skogman, Rush City, MN (US); Mario Carrillo, Minneapolis, MN (US)

(21) Appl. No.: 14/885,758

(22) Filed: Oct. 16, 2015

Related U.S. Application Data
(60) Provisional application No. 62/065,541, filed on Oct. 17, 2014.

(51) Int. Cl. A01K 97/12; A01K 99/00; A01K 97/01; H01R 24/30; H02J 3/38; H01R 13/73; H01H 23/24; G08B 21/18; H02J 3/32

(52) U.S. Cl. CPC A01K 97/125; G08B 21/18; A01K 99/00; A01K 97/01; H02J 3/32; H02J 3/383; H02J 3/386; H01R 13/73; H01H 23/24; H01R 24/30; H01R 2105/00

(57) ABSTRACT

Fishing alarm apparatuses are described herein. One apparatus can include an electrical circuit for receiving power from a power source, a set of contacts that, when they are connected to each other, cause an alarm component to be actuated, a shut off mechanism to turn off the actuated alarm component, a mechanism to turn on a light for illumination of an area around the apparatus, and wherein a fishing line is held between the set of contacts while waiting for an animal to pull on the line and remove it from between the set of contacts and once removed, the set of contacts connect with each other to cause the alarm component to be actuated.

### BACKGROUND OF THE DISCLOSURE

The present disclosure relates to an alarm apparatus that can be used to alert an angler that they have an animal on their line.

As many anglers experience, especially when ice fishing, it may be desirable to have a baited line in the water when the angler is not attending to the line. For example, anglers often like to fish late at night, but may also want to sleep during the night and fish early in the morning.

In such instances, if the baited line is left in the water, a fish or other animal may get caught on the hook (on which the bait is placed) or tangled in the line. Without someone attending to the line, the animal may be injured or die. In some instances, the animal can be large enough to pull the rod, onto which the line is attached, into the water, thereby losing that equipment and potentially putting the animal or other animals at risk due to the equipment getting tangled on an obstruction in the water or other possible problems.

Further, if the angler stays awake to fish or awakens to find an animal caught on his/her line, the angler will likely have to turn on the lights in the fish house or other structure in order to attend to the line. This may wake or annoy others that may be sleeping in the structure.

Additionally, some anglers believe that light shining down into the water distracts the fish and having the lights of the structure on may “spook” the fish and potentially reduce the amount of fish in the area or may make them reluctant to take the bait. The light in a fish house may also not be located near the fishing hole and, therefore, it may not be the best lighting for catching and/or removing fish.

### BRIEF DESCRIPTION OF THE DRAWINGS

FIG. 1A illustrates a front view of an alarm apparatus in accordance with one or more embodiments of the present disclosure.

FIG. 1B illustrates an elevated front view of an alarm apparatus in accordance with one or more embodiments of the present disclosure.

FIG. 1C illustrates another elevated front view of an alarm apparatus in accordance with one or more embodiments of the present disclosure.

FIG. 2 illustrates a back view of an alarm apparatus in accordance with one or more embodiments of the present disclosure.

### DETAILED DESCRIPTION OF THE DISCLOSURE

Fishing alarm apparatuses are described herein. For example, in one or more embodiments of the present disclosure an apparatus includes an electrical circuit for receiving power from a power source, a set of contacts that, when they are connected to each other, cause an alarm component to be actuated, a shut off mechanism to turn off the actuated alarm component, a mechanism to turn on a light for illumination of an area around the apparatus, and wherein a fishing line is held between the set of contacts while waiting for an animal to pull on the line and remove it from between the set of contacts and once removed, the set of contacts connect with each other to cause the alarm component to be actuated.

In another embodiment, an apparatus can include an electrical circuit for receiving power from a power source, a line holding mechanism having a body and a pair of contacts protruding from the body that, when the contacts are connected to each other, cause an alarm component to be actuated. This embodiment also includes a mechanism to turn on a light for illumination of an area around the apparatus and wherein a fishing line is held between the pair of contacts while waiting for an animal to pull on the line and remove it from between the pair of contacts and once removed, the pair of contacts connect with each other to cause the alarm component to be actuated. In some such embodiments, the apparatus can also include a shut off mechanism to turn off the actuated alarm component as discussed with respect to the first apparatus embodiment.

The figures herein follow a numbering convention in which the first digit or digits correspond to the drawing figure number and the remaining digits identify an element or component in the drawing. Similar elements or components between different figures may be identified by the use of similar digits.

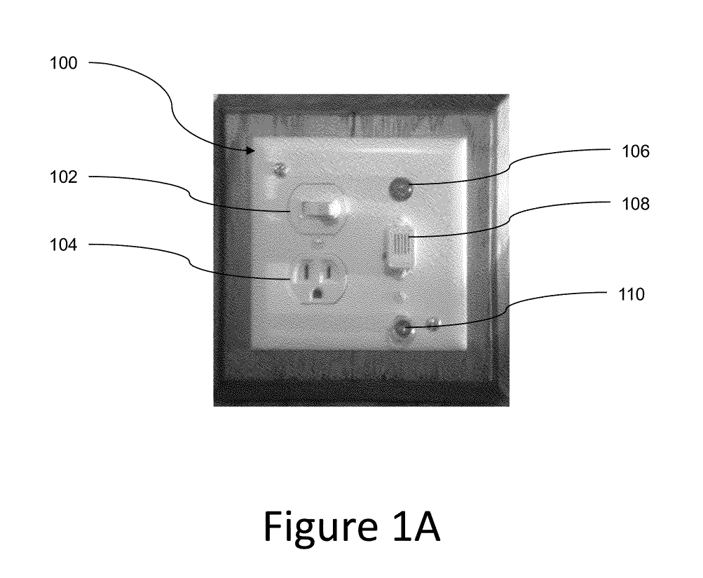

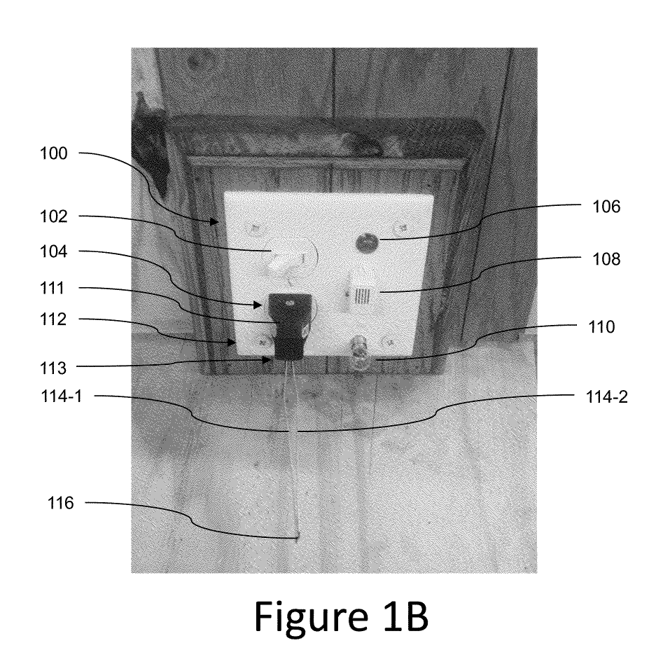

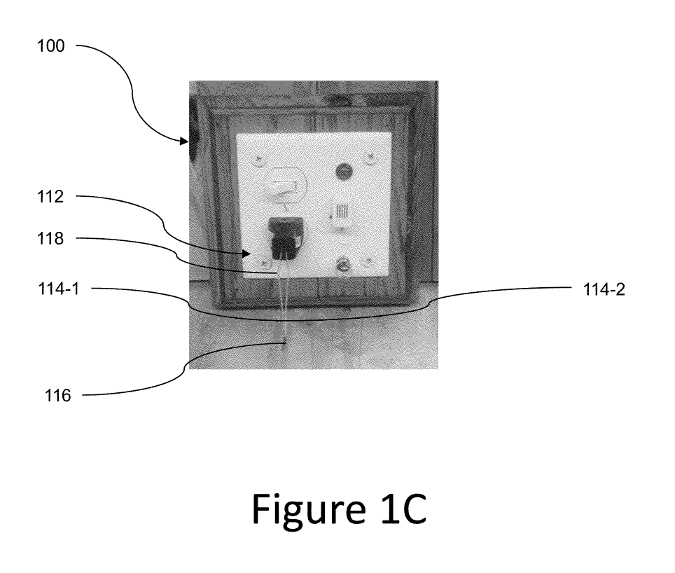

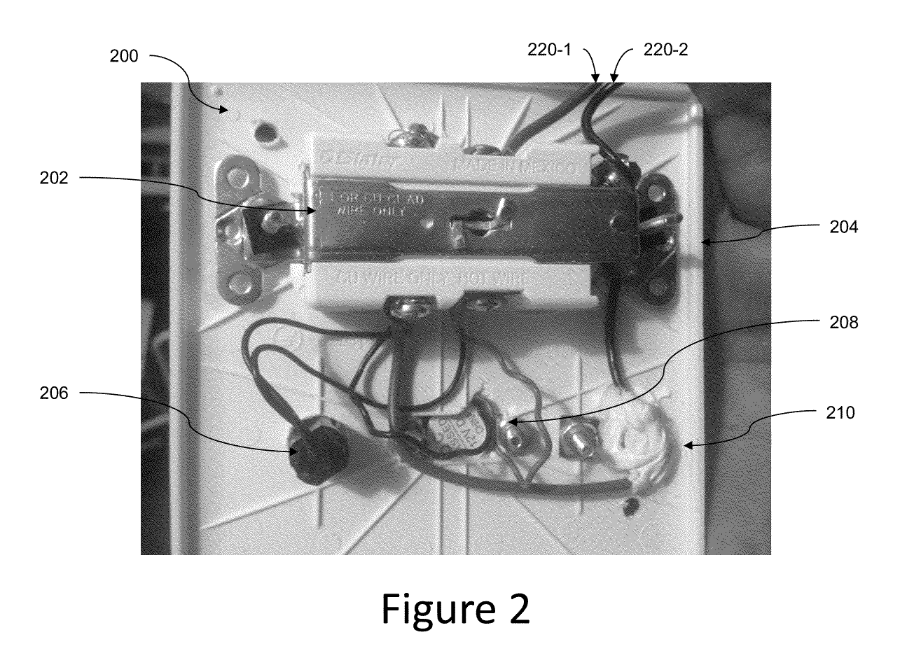

For example, 104 may reference element “4” in FIG. 1B, and a similar element may be referenced as 204 in FIG. 2. As will be appreciated, elements shown in the various embodiments herein can be added, exchanged, and/or eliminated so as to provide a number of additional embodiments of value.

FIG. 1A illustrates a front view of an alarm apparatus in accordance with one or more embodiments of the present disclosure. In the embodiment of FIG. 1A, the apparatus 100 includes a switch 102, an outlet 104, alarm components 106 and 108, and a light 110.

In various embodiments, the apparatus 100 can include one or more alarm components, such that a sense (sight, hearing, touch, etc.) of an angler can be alerted to something moving a line in the water. For example, in the embodiment of FIG. 1A, the apparatus 100 includes a speaker 108 for producing an audible alarm, and a light 106. As discussed herein, embodiments can have audible, visual, and/or tactile alarms that are generated to alert an angler.

A combination of alarm elements, such as that shown in FIG. 1A can be beneficial. For example, if the angler is sleeping in the dark, the audible alarm will awaken the angler and the light can guide the angler back to the fishing area of the fish house without the need for the angler to turn on the lights of the fish house. The reader should note that these and other sensory alarms (e.g., vibration emitting alarm, etc.) could be used separately, in some embodiments.

In some embodiments, the apparatus can be used with a plurality of fishing lines. For instance, an apparatus can have multiple switches, outlets, line holding mechanisms as discussed below, alarm components, and/or lights. In some such embodiments, the apparatus can have different audible, visual, and/or tactile alarms that are generated based on which line is moving.

Some embodiments could have different colored lights and/or vibrations in addition to, or instead of the audible sounds. In this manner, an angler can, for example, identify it is their line that is moving and check it. In such embodiments, the device may also have separate shut off mechanisms and/or lights to illuminate a particular area associated with each line that is being monitored, as will be discussed in more detail below.

The embodiment of FIG. 1A also includes a switch 102 which is used as a shut off mechanism to shut off the one or more alarm components. It should be noted that in some embodiments, each alarm component may have its own shut off mechanism. Further, as discussed herein, in some embodiments, the shut off mechanism to turn off the one or more actuated alarm components and the shut off mechanism to turn off the light for illumination of the area around the apparatus can be the same mechanism (e.g., one switch can be used for both functions).

In the illustrated embodiment of FIG. 1A, the switch 102 can be flipped from one direction to the other and in doing so, the switch 102 turns off both the audible alarm component 108 and the visual alarm component 106.

The switch 102 can also be used to turn on the light 110 which is used to illuminate the area around the apparatus 100. In some embodiments, the switch 102 simultaneously turns off the one or more alarm components 106 and 108 and turns on the light 110. Further, in some embodiments, the apparatus includes a shut off mechanism (e.g., a switch) to turn off the light for illumination of the area around the apparatus. And, in some such embodiments, one switch can be used to turn the light on and off.

In some embodiments, each alarm component and/or the light used to illuminate the area around the apparatus can each have their own switch. Although shown in the figures as a toggle switch, as used herein, the term switch can be any actuation mechanism that turns a component from on to off or vice versa.

In some embodiments, it is preferred that the apparatus 100 is mounted within the structure (e.g., to a wall, other surface of the structure, to a surface of an item, such as a piece of furniture). However, in some embodiments, the apparatus 100 can be portable and be powered, for example, by one or more batteries.

If the apparatus 100 is mounted over the location of a fishing hole (e.g., hole in the ice) then the light 110 can be used to illuminate the area around the hole. This can be beneficial as the light 110 is localized to the area around the hole and may not be as likely to wake the other occupants of the structure. For example, the light 110 may be bright near the hole, but not bright enough to brighten the entire structure, the light 110 is close to the hole, so it may provide better lighting around and/or into the hole.

In some embodiments, the light 110 also may not be so bright that it distracts the fish, but is still suitable for unhooking fish, hooking bait, and other functions. Further, in some embodiments, the light may be positioned or directed such that it illuminates the area around the hole but is not directed into the hole (e.g., light radiating from the light is directed generally parallel to the surface of the water in the fishing hole to reduce or minimize the amount of light entering the water).

In some embodiments, such as that shown in the embodiment of FIG. 1A, the apparatus 100 also includes an electrical connection (e.g., outlet 104) for connecting the line holding mechanism to the electrical system providing electricity to the apparatus. In this manner, the mechanism can use an electrical connection to monitor the fishing line, as will be discussed in more detail below. Another embodiment includes an electrical circuit for receiving power from a power source, a line holding mechanism having a body and a pair of contacts protruding from the body that hold a fishing line between the pair of contacts while waiting for an animal to pull on the line to remove the line from between the pair of contacts, and once removed, the pair of contacts move toward each other and cause an alarm component to be actuated. In such embodiments, the pair of contacts move toward each other such that they contact each other (to form an electrical circuit that causes an alarm component to be actuated (powered by the electrical circuit) and, in some embodiments, actuates the light that illuminates the area around the hole.

In other embodiments, the movement of the contacts toward each other can actuate other components to form a circuit. For example, one or more of the contacts may have a conductive element within the body that moves to contact another conductive element to form a circuit that actuates one or more alarms and/or the light when the fishing line is removed from between the contacts.

FIG. 1B illustrates an elevated front view of an alarm apparatus in accordance with one or more embodiments of the present disclosure. Similarly to the embodiment shown in FIG. 1A, in the embodiment of FIG. 1B, the apparatus 100 includes a switch 102, an outlet 104, alarm components 106 and 108, and a light 110.

This embodiment also provides a line holding mechanism 112 that includes two contacts 114-1 and 114-2 that can be positioned to be in contact with each other at some point along their lengths (in the embodiment of FIG. 1B, they are constructed to contact each other near the end 116 for each contact, however, embodiments are not so limited.

In some embodiments, such as that shown in the embodiment of FIG. 1B, the line holding mechanism 112 includes a body having an electrical connection (e.g., the body is has conductive elements that plug into outlet 104 shown in FIG. 1A) for connecting the line holding mechanism to the electrical system that provides electricity to the apparatus. As discussed above, in this manner, the mechanism can use an electrical connection to monitor the fishing line.

In the embodiment shown in FIG. 1B, the connection is made via the electrical outlet. For example, in some embodiments, the electrical circuit includes a multi-purpose electrical outlet (e.g., a 12 Volt outlet) and wherein the body includes conductive elements that removably plug into the outlet.

Such an embodiment can be beneficial in that when the apparatus is not in use as a fishing alarm apparatus, the line holding mechanism can be unplugged from the outlet and other items (e.g., radio, hot plate, television, etc.) can be plugged into the outlet. Further, in such embodiments, should the line holding mechanism become damaged, it can be easily replaced, or a different type of mechanism (e.g., more sensitive, less sensitive, etc.) a first line holding mechanism can be replaced by another, different or replacement line holding mechanism.

Additionally or alternatively, the line monitor can be integrated into the apparatus such that it is non-removable (e.g., hard wired directly to the electrical system of the apparatus rather than plugged into an outlet). Such embodiments can be beneficial, for example, as the line holding mechanism cannot be misplaced and/or the connection between the electrical system and the line holding mechanism can be more reliable, among other benefits.

FIG. 1C illustrates another elevated front view of an alarm apparatus in accordance with one or more embodiments of the present disclosure. The apparatus 100 of FIG. 1C includes a line holding mechanism 112 that has contacts 114-1 and 114-2 which contact each other at one end 116 of the contacts (e.g., at the tip).

The contacts 114-1 and 114-2 illustrated also have a bend 118 in them such that they bend toward each other. This can be utilized to provide a force to hold a fishing line between the contacts and can also provide force to urge the contacts to touch to each other.

For example, in some embodiments such as that shown in FIG. 1B, each of the pair of contacts has a first end 113, a second end 116, and an elongate central portion between the first end 113 and second end 116. The elongate central portion of at least one of the pair of contacts can include a bent portion (e.g., bent portion 118 in FIG. 1C) between the first end and the second end as shown in FIG. 1B. In some such embodiments, the first end can attached to the body, the elongate central portion is extending away from the body, and the second end is spaced apart from the body.

In the embodiment of FIG. 1C, the contacts 114-1 and 114-2 are mounted to a base portion at the other end such that they do not contact each other at that end. Electrical wires may be attached to these ends (or elsewhere) of the contact to provide electricity to allow for an electrical circuit to be made when the two contacts 114-1 and 114-2 are connected (e.g., touching).

In this embodiment, when the contacts 114-1 and 114-2 connect, electricity flows through the circuit such that one or more alarm components are triggered to actuate and produce their alarming signal. The actuation of these components will be discussed in more detail herein. In such an embodiment, the line to be monitored is placed between the contacts 114-1 and 114-2 thereby keeping them apart and thereby having the contacts 114-1 and 114-2 provide enough force to hold the line in place between the contacts 114-1 and 114-2, but not so tightly as to not allow the line to be removed from between the contacts 114-1 and 114-2 by an animal in the water pulling on the line.

FIG. 2A illustrates a back view of an alarm apparatus in accordance with one or more embodiments of the present disclosure. The embodiment of 2A corresponds to the back side of the embodiment of FIG. 1B.

In the embodiment of FIG. 2A, the apparatus 200 includes a switch 202, an outlet 204, alarm components 206 and 208, and a light 210. In this view, the connections of the various components can be seen. For example, the switch 202 is connected such that when an alarming signal (e.g., via the one or more alarm components 206 and 208) has been initiated (e.g., when two electrical contacts are connected) and the switch 202 is flipped, electricity flowing through the wires to the alarm components 206 and 208 is cut off, thereby, shutting off the one or more alarm components 206 and 208. The wiring also allows for the light 210 to be illuminated based on electricity flowing there through.

As illustrated in the embodiment of FIG. 2A, one or more of the components can be combined together to form a combined device. In this example, the switch 202 and the outlet 204 can be combined together and are shown as one unit in FIG. 2.

FIGS. 2B illustrate an angled back view of an alarm apparatus in accordance with one or more embodiments of the present disclosure. FIG. 2B provides two electrical connectors 220-1 and 220-2 that allow for connection of the apparatus 200 to a power source. As discussed above, this can be, for example, connected to an electrical supply (such as line power from a power plant, one or more batteries, generators, solar cells, wind turbines, and/or other power sources.

In some embodiments, the power source can be attached to the apparatus and, therefore, power can be obtained in applications where line power may not be available. For instance, in some embodiments, the power source is a battery, solar cell, or wind turbine attached to the apparatus.

The foregoing descriptions of specific embodiments of the present invention have been presented for purposed of illustration and description. They are not intended to be exhaustive or to limit the present invention to the precise forms disclosed, and many modifications and variations are possible in light of the above teaching.

The example embodiments were chosen and described in order to best explain the principles of the present invention and its practical application, to thereby enable others skilled in the art to best utilize the present invention and various embodiments with various modifications as are suited to the particular use contemplated. As one of ordinary skill in the art will appreciate upon reading this disclosure, various embodiments of the invention can be performed in one or more devices, device types, and system environments.

Combination of the above embodiments, and other embodiments not specifically described herein will be apparent to those of skill in the art upon reviewing the above description. The scope of the various embodiments of the disclosure includes other applications in which the above structures and methods can be used. Therefore, the scope of various embodiments of the disclosure should be determined with reference to the appended claims, along with the full range of equivalents to which such claims are entitled.

In the foregoing Detailed Description, various features may have been grouped together in a single embodiment for the purpose of streamlining the disclosure. This method of disclosure is not to be interpreted as reflecting an intention that the embodiments of the invention require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A fishing alarm apparatus, comprising:
an electrical circuit for receiving power from a power source;
a set of contacts that, when they are connected to each other, cause an alarm component to be actuated;
a shut off mechanism to turn off the actuated alarm component;
a mechanism to turn on a light for illumination of an area around the apparatus; and
wherein a fishing line is held between the set of contacts while waiting for an animal to pull on the line and remove it from between the set of contacts and once removed, the set of contacts connect with each other to cause the alarm component to be actuated.

2. The apparatus of claim 1, wherein the apparatus includes a shut off mechanism to turn off the light for illumination of the area around the apparatus.

3. The apparatus of claim 2, wherein the shut off mechanism to turn off the actuated alarm component and the shut off mechanism to turn off the light for illumination of the area around the apparatus are the same mechanism.

4. The apparatus of claim 1, wherein the power source is a battery attached to the apparatus.

5. The apparatus of claim 1, wherein the power source is a solar cell attached to the apparatus.

6. The apparatus of claim 1, wherein the power source is a wind turbine attached to the apparatus.

7. A fishing alarm apparatus, comprising:
an electrical circuit for receiving power from a power source;
a line holding mechanism having a body and a pair of contacts protruding from the body that, when the contacts are connected to each other, cause an alarm component to be actuated;
a mechanism to turn on a light for illumination of an area around the apparatus; and
wherein a fishing line is held between the pair of contacts while waiting for an animal to pull on the line and remove it from between the pair of contacts and once removed, the pair of contacts connect with each other to cause the alarm component to be actuated.

8. The apparatus of claim 1, wherein the apparatus further includes a shut off mechanism to turn off the actuated alarm component.

9. The apparatus of claim 1, wherein each of the pair of contacts has a first end a second end, and an elongate central portion between the first end and second end.

10. The apparatus of claim 9, wherein the elongate central portion of at least one of the pair of contacts includes a bent portion between the first end and the second end.

11. The apparatus of claim 9, wherein the first end is attached to the body, the elongate central portion is extending away from the body, and the second end is spaced apart from the body.

12. The apparatus of claim 9, wherein the alarm component is a mechanism to generate an audible alarm.

13. The apparatus of claim 9, wherein the alarm component is a mechanism to generate a visual alarm.

14. The apparatus of claim 9, wherein the alarm component is a mechanism to generate a tactile alarm.

15. A fishing alarm apparatus, comprising:
an electrical circuit for receiving power from a power source;
a line holding mechanism having a body and a pair of contacts protruding from the body that hold a fishing line between the pair of contacts while waiting for an animal to pull on the line to remove the line from between the pair of contacts, and once removed, the pair of contacts move toward each other and cause an alarm component to be actuated.

16. The apparatus of claim 15, wherein the apparatus includes a mechanism to turn on a light for illumination of an area around the apparatus.

17. The apparatus of claim 15, wherein the apparatus includes a mechanism to turn on a light for illumination of an area around the apparatus when the alarm component is actuated.

18. The apparatus of claim 15, wherein the pair of contacts move toward each other such that they contact each other and cause an alarm component to be actuated.

19. The apparatus of claim 15, wherein the alarm component includes at least two mechanisms that generate an audible, visual, or tactile alarm.

20. The apparatus of claim 15, wherein the electrical circuit includes a multi-purpose electrical outlet and wherein the body includes conductive elements that removably plug into the outlet.
